(19) United States
(12) Patent Application Publication
(10) Pub. No.: US 2002/0131567 A1
(43) Pub. Date: Sep. 19, 2002

(54) Device and method for repetitive communication of messages

(76) Inventor: Stephen Paul Maginas, Rock Island, IL (US)

Correspondence Address: Stephen P. Maginas, 3404 25th Street, Rock Island, IL, 61201, US

(21) Appl. No.: 10/092,074

(22) Filed: Mar. 6, 2002

Related U.S. Application Data
(60) Provisional application No. 60/276,084, filed on Mar. 16, 2001.

(51) Int. Cl. H04M 11/00

(52) U.S. Cl. 379/91.01; 379/93.12

(57) ABSTRACT

This invention is an apparatus and method to facilitate the repetitive communication of messages between parties by placing a single message in machine readable data upon a card, or substrate, so that all persons using that card are fully aware of the data to be transmitted. Repetition is achieved by communicating a fixed message by use of the card, rather than in allowing variation of the disclosed message, and in directions or additional information on the card that indicates its use and purposes. Data on the card may be communicated by a variety of devices including standard retail point of sale readers for credit cards, and by telephone keypads or standard keyboards on computers. The method comprises the distribution and communication of the message cards, and permits flexibility in the responses of those receiving the messages.

### CROSS-REFERENCE TO RELATED APPLICATIONS

Please refer to Provisional Patent Application 60/276,084, filed on Mar. 16, 2001.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates in general to registers bearing data, and in particular to registers permitting the communication of messages comprised of such data and fully disclosed upon the register. This invention also relates to a method facilitating communication of messages from registers over telecommunication networks, by use of a variety of input devices.

The history of electronic communication includes many devices intended to bring to an individual the information held by, or assistance from, a distant institution or individual. Some devices have resembled wallet-sized cards, also known as registers or card-like substrates, as a means to direct activity in other devices. More recently, integrated circuitry has permitted inclusion of very complex devices within the cards.

Earlier cards have directed activity in other, complex devices by using a variety of machine readable data, such as punched holes allowing mechanical or optical contacts at the sites of the holes. The location of those holes is decoded by the device reading the data on the card. While cards such as the standard Hollerith card or punchcard may have borne both human and machine readable data, prior inventions did not teach that one such card would identify an intended recipient other than the user and suffice to transmit to that recipient a message disclosed upon the card in human readable data.

As used herein, machine readable data is defined as data that is not designed to be read by the naked, unaided human eye or hand, but can be interpreted by machinery. Human readable data can be read by the naked, unaided human eye or hand (e.g. Braille), and can be reproduced by the characters on a standard QWERTY keyboard, by use of a DTMF keyboard on a telephone, a remote television control computer mouse, or by other common devices whereby commonly used characters may be reproduced. Full disclosure of machine readable data, as used below, means the display of a rendering of all machine readable data such that a human may read and fully reproduce all of the machine readable data.

An example of a punchcard is found in U.S. Pat. No. 3,317,715 (S. Talbot, May 2, 1967), wherein multi-color coding supplemented the standard data on a punchcard and conveyed more machine readable data than would be disclosed by the standard punched holes. However, this invention did not teach that the card bears or reveals all machine readable data in human readable text, nor that a single card suffices to identify an intended recipient and transmit a message disclosed upon the card in human readable text.

Many patents were issued teaching the use of punchcards to direct telephones to dial a certain number, as in U.S. Pat. Nos. 2,505,069 (H. C. Savino, Apr. 25, 1950); 3,124,659 (E. R. Andregg, May 10, 1964); 3,194,893 (C. C. Auel, Jul. 15, 1965); 3,514,549 (J. D. Askew, May 26, 1970); and 4,817,136 (R. M. Rhoads, Mar. 28, 1989). However, those inventions did not teach that the card directing a telephone to dial a certain number would communicate a specific message upon creation of the telephonic contact.

U.S. Pat. Nos. 3,345,463 (J. E. Hynes, Oct. 3, 1967) and 3,510,593 (R. E. Chappell, May 5, 1970) teach that a separate device on the telephone would create an audibly coded signal to be relayed as a message. More recent patents teach use of a card to dial a telephone number and then display to the card user, on a screen, a symbol representative of portion of the machine readable data on the card, as in U.S. Pat. No. 4,817,136 (R. M. Rhoads, May 28, 1989). A card has also been used to allow a person to reconfigure a telephone so that it acts as if it is a telephone assigned to the card holder; however, the face of the card only identifies the holder and communicates no message to any other recipient, in U.S. Pat. No. 5,524,049 (T. Akiyama, Jun. 4, 1996).

As with other card dial telephones noted above, a card directing the dialing of the telephone does not bear a message to be communicated and does not, alone, suffice to communicate data to a distant recipient.

U.S. Pat. No. 3,999,042 (D. Silverman, Dec. 21, 1976) teaches the use of microscopic optical perforations to uniquely identify a particular card holder for access to a secured facility, but for security purposes the coding of those perforations is not disclosed in human readable data.

Some inventions teach the use of data on one card to allow use of a telephone and other cards, or buttons, that designate certain items to be ordered through that telephone from a distant supplier, as in U.S. Pat. Nos. 4,897,865 (A. Canuel, Jan. 30, 1990); 4,682,014 (T. Iwama, Jul. 21, 1987); and 6,014,430 (P. J. Gosney, Jan. 11, 2000). Others use the reading of a sequence of one-dimensional bar codes to enter the telephone number, the holder's ID, then the items to be ordered, as in U.S. Pat. Nos. 5,465,291 (J. Barrus, Nov. 7, 1995); 6,144,848 (J. F. Walsh, Nov. 7, 2000); and 6,230,790 (J. F. Walsh, May 15, 2001). In those inventions, there is no single card that bears both the data required to direct another apparatus to contact a recipient, and the data to place an order.

As with prior cards on which machine readable data is encoded, there is moreover no express denomination, or labeling, that the card bears a full disclosure, rendered in human readable data or indicia, of all machine readable data on that same card. One-dimensional bar codes, on occasion, only disclose all machine readable data, but that disclosure is not labeled as such. Bar code data disclosures generally include codes to start and stop the machine reading the bar code in the form of asterisks or quotation marks; see HTML file entitled “Bar Code Mechanics” available at www.snx.com/faq/html, Jan. 28, 2002. Magnetic ink character recognition (MICR) codes display various characters on the ordinary bank check, but not all in characters that are human readable or reproducible; see HTML file entitled “A Brief Introduction to MICR Technology” available at www.mydataflo.com/wt_s6.asp, Jan. 28, 2002. The flux of a magnetic particle on a magnetically sensitive plastic stripe is not visible to the unaided human eye.

The function of the machine readable data, to direct activity of a device, is conventionally interpreted as a function separate from the human readable data on a card. It has not been considered necessary, nor obvious, that the data should reveal to the holder or other user the content and functions of the machine readable data. Such data, in prior inventions cited herein, would be considered unnecessarily redundant directions on use of the device reading the card's machine readable data. Such disclosures of data could even compromise security or privacy, as many prior inventions focus on protection of a card holder's data from use by third parties. For example, the card permitting access to a certain door would not disclose on its face the location of that door, nor its code in machine readable data, since loss of the card may teach third parties how to obtain access to the very door meant to be kept secure. See “Smart Cards Explained: How Smart Cards Secure Transactions and Protect Users”, Red Herring, Jan. 16, 2001, pp. 82-83, a magazine article on smart cards and functions that are needed to protect privacy and make the cards effective.

Furthermore, even as advances in telecommunications devices allowed the writing and rewriting of more data to be read by machinery, upon a single card, the additional data was nowhere taught as either sufficing to both direct the reading device to contact a certain disclosed recipient and to also communicate a complete message. It appears that the increase in the machine readable data is part of a trend leading to increasing flexibility in use of the card with complex devices that read the data, and the added commands and data cannot be fully rendered in human readable data upon one easily usable card.

In those inventions, cards bear encoded and disguised data in magnetic stripes to preserve confidentiality of medical information and access to same, as in U.S. Pat. No. 6,112,986 (R. S. Berger, Sep. 5, 2000). U.S. Pat. No. 6,000,608 (R. E. Dorf, Dec. 14, 1999) teaches the need for a secret PIN number to utilize a card, with no disclosure on the card beyond the bank identification number as a unique identifier for each card. IBM Technical Disclosure Bulletin 77C00982, May 1977, pp. 480-4801, describes the use of a card to hold medical data that would have to be read by a magnetic stripe reader or an optical reading device, and does not show a full disclosure of the medical data on the face of the card. That card also does not convey data to any device other than the reader, nor does it bear code that controls any device.

Some inventions, as in U.S. Pat. No. 5,493,105 (N. R. Desai Feb. 20, 1996) teach the use of business cards to bear machine readable data that exceeds that which can fit on face of a card, and permit storage of same data. However, those do not allow that data to direct communication of a message to a certain person named on the card.

As with card dial telephones, some inventions use data on a cards to obtain access to certain locations such as a website on the internet, but do not direct sending of a certain message to an intended recipient. In U.S. Pat. No. 5,940,595 (W. L. Reber, Aug. 17, 1999) the card bears a logo of a particular website on its face, and after navigating to a website a display shows the logo to the user of the card to visually confirm the website that was to be accessed. It does not display that logo, or any other message, to a distant recipient, or to any person other than the user of the device.

Many patents describe cards bearing integrated chips that enable dialing of many telephone numbers, or holding extensive other data, as in U.S. Pat. No. 4,900,902 (K. Sakakibara, Feb. 13, 1990). U.S. Pat. No. 4,817,135 (R. M. Rhoads, Mar. 28, 1989) teaches use of an integrated chip to generate dial tones to dial a telephone number, but no message is conveyed to the person answering the telephone call. Cards that reveal a portion of the machine readable data in variable displays such as thermal sensitive film, as in U.S. Pat. No. 5,932,869 (S. Gottlich, Aug. 3, 1999), do not teach that all machine readable data borne in the card is ever revealed to the card holder or card user. In fact, prevention of the reading and reproduction of the machine readable data is seen as a means to prevent fraud, as in U.S. Pat. No. 5,834,756 (J. Gutman, Nov. 10, 1998). U.S. Pat. No. 4,677,657 (M. Nagata, Jun. 30, 1987) teaches that a card with imbedded chips can transform an audible signal into tones that can be sent to another similar card. However, the digital message is not disclosed in human readable data, is not fixed, is not useable by third parties, and can only be received and decoded by similar cards. The method disclosed by U.S. Pat. No. 4,491,725 (L. E. Pritchard, Jan. 1, 1985) involves use of a card where security concerns dictate concealment of medical data, which data is not fixed, which requires an immediate response to effect its purpose, and requires input of treatment codes in addition to the machine readable data of the card.

Some patents describe methods to relay information, such as purchase receipts from cellular or retail point of sale devices, but do not teach that the message from a single card would alone bear sufficient data to convey both the complete message as well as the address of the intended recipients. Those patents include U.S. Pat. Nos. 5,719,918 (B. Serbetciouglu, Feb. 17, 1998); 6,064,990 (P. J. Gosney, Jan. 11, 2000); 6,067,529 (D. Ray, May 23, 2000); and 6,185,542 (J. C. Moran, Feb. 6, 2001). Other methods, as in U.S. Pat. No. 4,229,794 (C. E. Foster, Oct. 21, 1980), combine data from a magnetic stripe with other data about a product, to issue a label combining the two to the holder or user of the card. Such data is not fixed nor is machine readable data fully disclosed on the card; no intended, distant recipients are noted in the machine readable data nor in the human readable data; and the machine readable data on the card must be supplemented by other data regarding product weight. If machine readable data were fully disclosed on the product card and there were a price change, the user would be misled as to the function of the product card.

Identification cards have been used to signify the originator of a message, but then require entry of a separate set of machine readable data to convey a complete message to a distant recipient. See “Component Distributor Improves Operations—Inside and Out”, Frontline Solutions, March, 2001, pp. 14-15.

Some patents teach the addition of sound or other data that can be encoded on a photograph (U.S. Pat. No. 5,995,193, T. M. Stephany, Nov. 30, 1999) or on a page with text (IBM Technical Disclosure Bulletin 75C00310, December 1974, pp. 2164-2165; IBM Technical Disclosure Bulletin 82A00430, December 1981, p. 3292). However, these do not teach the disclosure of all encoded data, but only of an audible rendition of portions that may be intuitively associated with the image. Similar to the functions of those devices is the mechanism of IBM Technical Disclosure Bulletin 60C00024, February 1960, p. 31, which shows a device that allows simultaneous recordation of a typed character in proximity to its representation in the flux borne on a magnetic stripe. In those devices, the encoded machine readable data does not suffice to direct the functions of devices in order to convey a message to a person other than the user of the card and reading device.

The features of those inventions serve to render each card a device uniquely tailored for use by a particular holder, so that if the card came into the possession of a third party the uses of the card would be unknown or limited.

As to the institution that makes such cards, those added features are designed to give each card holder control over the functions to be accomplished by the card and over the method actuated. That control necessarily requires that third parties (such as a retail store clerk) do not know the entire content of the machine readable data upon the card. It is the card holder's option to reveal a PIN number, address, or other data, in order to require the card maker and the third party to fulfill agreements such as provision of funds or access to a cite on the terms chosen by the card holder. See “A New Credit Card Scam”, Time, Jun. 5, 2000, pp. 54-55. More recently, this trend has accelerated with privacy concerns that have led to an increase in the complexity of features meant to be solely within the card holder's control and knowledge. All of those features, and the increase of data capacity of integrated circuit (IC) chips, have rendered impossible the full disclosure of data or functions of each card.

The current trend in use of machine readable data on cards exacerbates difficulties due to the right to preserve, or relinquish, one's privacy as to financial or other personal information. The trend is toward cards and devices of great complexity and large capacity that store such large amounts of data that it cannot be disclosed in human readable data on the card, that are designed to use their large capacity to encrypt machine readable data, or to provide hidden functions. Therefore, both the cardholder and a third party user may fear that the use of those cards will convey information that the card holder chooses to keep private. A resulting fear of legal liability by third party users limits the functions of a data bearing card. Therefore, to adequately and expressly convey that the card maker and the card holder have opted out of any privacy protection for the data on the card, the machine readable data and the card's functions can be fully disclosed on the card. When necessary, that full disclosure can be denominated as such on the card. By the act of providing that card to a third party, or in using that card, the card holder would expressly relinquish his or her expectation of privacy as to that machine readable data. Thus, as the complete machine readable data on the card would suffice to allow execution of the complete function of the card, and as that function is fully disclosed, no third parties or card makers would need to fear any liability in making or using the card, or in transmitting the machine readable data on that card.

In addition, there are many duties the card maker can fulfill only by an exercise of discretion after data is received from a card holder. There are numerous situations where an institution can provide a service only when it can allow a certain time to elapse before to deciding how to respond to a request, such as a claim for insurance coverage after an auto accident, and where a third party is needed to transmit information to the institution. Current trends are toward reducing the time allowed to an institution to respond, and placing greater immediate control in the hands of the customer, an approach following a different path from this invention. Such trends increase the time and energy costs for the customer, who must spend long periods on a telephone awaiting audible prompts and entering information. See HTML file entitled “Making Contact: Virtual Call Centers Zero in on Customer and Enterprise Needs”, available at www.cisco.com/warp/publi...s_fea_how_{—}001/article_prt.html, Mar. 16, 2001. The institution, or repository of information, operated by the card maker cannot effectively utilize cards to aid in transmission of information or guarantee insurance coverage when the functions of the card are solely within the card holder's control. Moreover, communication in such situations can be greatly eased by devices that allow the card holder to repetitively transmit messages to the institution that will then decide whether, and how, to take action in a series of similar circumstances. Energy costs can also be reduced by allowing issuance of fixed messages without a need for lengthy telephone contact.

### BRIEF SUMMARY OF THE INVENTION

Therefore, it is an object of the invention to allow communication of fixed messages by displaying on a card, in data readable by a human, indicia of the machine readable data encoded and affixed thereupon, without the need for card holders or users to add further data It is also an object of the invention to allow the data encoded thereupon to direct reading devices to transmit the disclosed data to the cardmaker or other designated recipients, so they can determine the response appropriate in the circumstances. It is also an object of the invention to inform members of an institution of repetitive events that may trigger various institutional responses. It is also an object of the invention to simplify the communication of data by fixing the machine readable data to be transmitted, such that card users are at all times able to effectively understand the functions of the card. It is also an object of the invention to denominate, or label, that all machine readable data is fully disclosed so that any user of the card can accurately actuate the functions of the card by placing it into communication devices. It is also an object of the invention to allow any user to fully recreate the machine readable data on a card by reliance on the human readable data, or indicia, on the card, as the format in which it should be transmitted and the definition of the data elements of the machine readable data may be fully disclosed, and thereby encourage the transmission of data on the cards through a variety of communication devices other than standard magnetic stripe or optical code readers. It is also an object of the invention to act as an express relinquishment of the expectation of privacy as to the machine readable data on the card. It is also an object of the invention to reduce energy usage of devices for the transmission of simple, repetitive messages by reducing the time required to enter such data and therefore reduce the time required to have communication devices active for input and transmission. It is also an object of the invention to provide a method by which a certain message on a substrate can be repetitively communicated to distant recipients.

### BRIEF DESCRIPTION OF THE SEVERAL VIEWS OF THE DRAWINGS

FIG. 1A displays one side of a preferred embodiment of the invention, including the machine readable data and human readable data.

FIG. 1B displays the other side of a preferred embodiment, including the full disclosure of machine readable data in human readable data that can be decoded by the unaided human.

FIG. 2 displays, in part, a flowchart with steps to be followed by an institution to enable transmission of machine readable data using the invention.

FIG. 3 continues the flowchart with steps to be followed by an institution to enable transmission of machine readable data using the invention.

FIG. 4 comprises a flowchart illustrating use of other telecommunication devices that would aid in transmission of data on or in the invention.

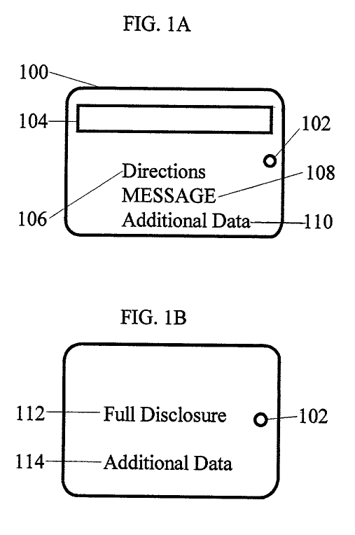

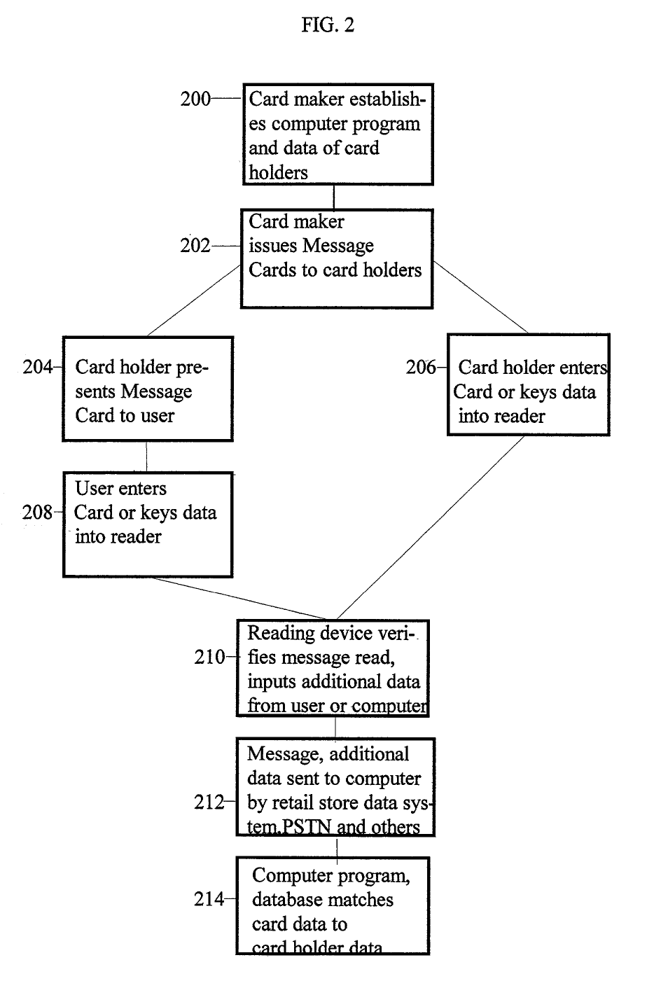

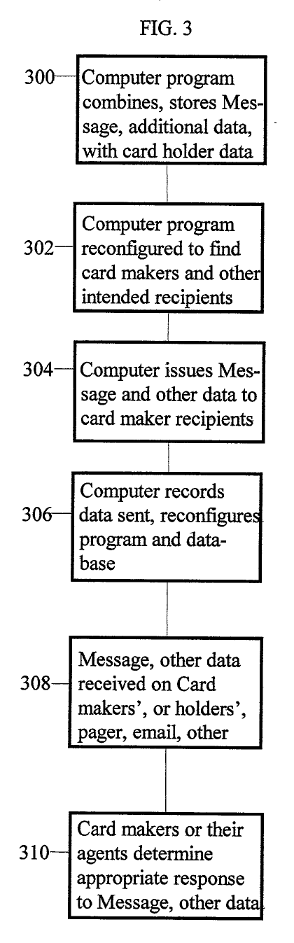

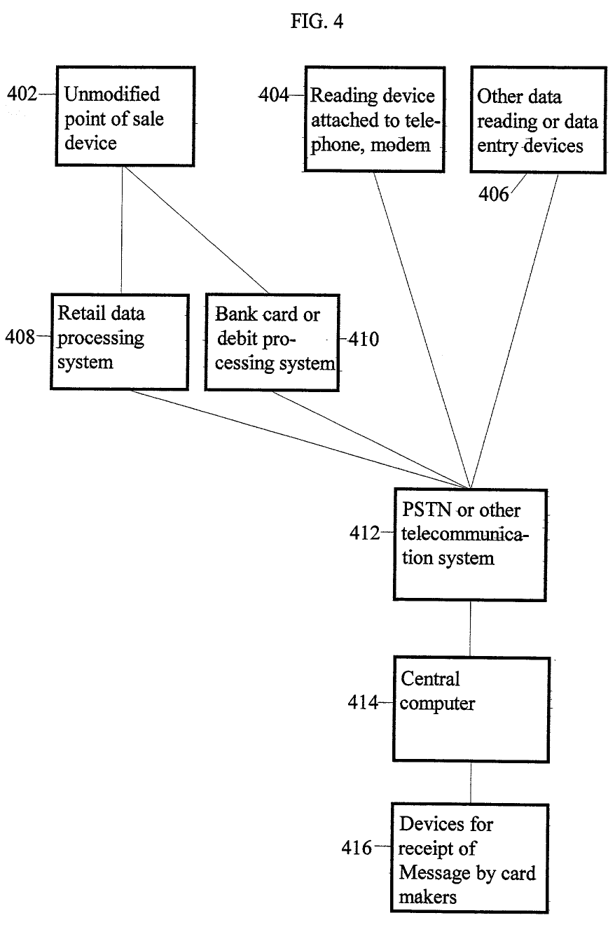

### DETAILED DESCRIPTION OF THE INVENTION

This invention is a communication apparatus comprising a substrate upon or within which is a combination of programmable machine readable data with full disclosure of that machine readable software and command data, upon or within the substrate in the form of human readable data. The substrate may also bear, in human readable data, directions for use of the Message Card and disclosure of a selected portion of the machine readable data as the message to be received by designated card makers, their agents or other persons.

This invention is referred to as a “Message Card”. That name is meant for the convenience of the reader and does not comprise a limitation on the invention. The user of the Message Card is the person placing the card in a data reader or otherwise entering data disclosed in the card into a transmission system.

Each entry of the machine readable or human readable data into a device to read same results in issuance to the card maker, its agents, or recipients other than the user, of at least a selected portion of the same message as previously sent by use of the functions of that card. Both the human readable data and the machine readable data comprise functionally descriptive material, as will be shown by the uses which they facilitate in this invention. An embodiment of the substrate may comprise paper, polyvinyl chloride (PVC), other plastics, or any appropriate substance as known in the art, and may be card-like and shaped as a standard credit card, or any other shape upon or into which the machine readable memory may be placed. The function of the combination of human and machine readable data would directly affect the use of the Message Card by card holders and other users, as that function both actuates electronic and mechanical machinery in discrete sequences and in particular and useful ways, and also teaches card holders and users how to cause such unique actuation, as would the labels upon other articles of manufacture.

The combination of commands and data upon the machine-readable memory are sufficient to reconfigure a standard unmodified point of sale device, a communication device, other data readers, and associated computer devices to transmit the message or messages, in the encoded machine readable content of which was previously disclosed in human readable data, along with additional optional data, to the central computer of the card maker or its agents. The software and/or data in the central computer then would be reconfigured and result in transmission of the appropriate message and data to the card maker, its agents or to persons other than the user of the Message Card.

### Preferred Embodiment

Refer now to Figures one through four, which are overall drawings of the preferred embodiment of the invention.

The preferred embodiment of the invention would be for use in reporting of a personal auto accident. Upon or within a card-like substrate 100 would be the human-readable data 106,108,110,112,114 that would encourage the card holder, the person insured and in the accident, to either enter the card into a device to read same 402,404,408 and issue the message 416, or to hand the card to a user who may do so, or to use a keypad on a telephone, or another device 406 to enter the disclosed commands and other data Those other third party users would be hospital billing clerks, tow truck operators, sellers of property repair services or goods, and others. The machine readable memory upon or within the substrate 104 would comprise data such as a customer or policy number of the insured card holder, the data indicating the possible occurrence of a covered loss, commands that would reconfigure the reading device as a means to route such data through a retail sales system 408, banking data system 410, and/or other devices 412 so that the new functions of those systems would allow the combination of the message and/or other optional commands or data to reach the computer of the card maker or its agents. Those commands can also operate to reconfigure a device such as a telephone and a modem to enable dialing of a telephone number to which to transmit the message on the card. One face of the substrate may bear human readable directions 106 and a disclosure of the message 108 to be sent, which together may comprise data such as “The following message will be transmitted upon use of this card: I HAVE HAD AN AUTO ACCIDENT. PLEASE CONTACT ME OR MY AGENT.”

The ordinary credit card reader 402 is a device comprised of a magnetic head and electronic circuitry in a cabinet. The machine readable data, if on a magnetic stripe, may conform to American National Standards Institute (ANSI) or the International Organization for Standards (ISO) standards and configurations widely adopted as common within the industry, such as those at ISO/IEC 7811 et seq., as are well known to those of ordinary skill in the art. Such standards may be obtained from ANSI at 11 W. 42d St., 13th Floor, New York, N.Y., 10036, USA. Standards of other industry organizations, both in the U.S.A. and abroad, such as those of the American Bankers Association in its use of Bank Identification Numbers to facilitate current uses of credit cards, also enable one with ordinary skill to make the invention. A general description of magnetic encoding can be found at the HTML file entitled “ID Tech's Guide to Magnetic Encoding on Cards”, available at www.idt-net.com/magnetic/index/cfm, Jan. 22, 2002.

Devices and methods to enable transmission of the machine readable data may be found in industry descriptions of telecommunications via Point of Sale and other data devices. A selected embodiment of a magnetic stripe reader is the IBM brand SureOne, a complete point of sale package for retail sales use.

In an embodiment of the invention such as this, wherein the machine-readable memory 104 is represented within a magnetic stripe, the memory would contain one to three tracks of magnetically coded information. Following industry standards cited above, track one would comprise alphanumeric characters while those in tracks two and three would only be numeric characters. The card holder may be differentiated by entries into areas in which the primary account number is ordinarily encoded (comprising up to 19 characters in track one) or where the card holder's name is ordinarily encoded (comprising up to 26 characters in track one). Control and reconfiguration of the function of the reader 402,404,406, selection of communication lines from the reader to transmit data to the central computer 408,410,412, reconfiguration of the central computer 414 to permit evaluation and recombination of data within the central computer, and transmittal of the data to the card maker, its agents or intended recipients other than the card user 416 may all be controlled by machine readable data encoded in the remaining areas of tracks one, two and three. The human readable data would include a full disclosure 112 of all machine readable data 104, with one embodiment of same disclosure being as follows: “The machine readable memory of this substrate contains only the following alphanumeric characters: ‘12345 . . . ABCD . . . XYZ’, with the MESSAGE communicated to comprise the following subset of same alphanumeric characters: ‘LMNOP’.” Said alphanumeric characters may be revealed in American Standard Code for Information Exchange (ASCII) or other appropriate human readable coding sufficient to communicate the content of the machine readable data to the card holder or users 112. A card-shaped and wallet sized substrate would suffice to bear all necessary machine readable data, based upon industry standards for such data. In use of the card, the machine readable encoded data would be transmitted to the computer, wherein the machine readable data is reconfigured so that its signification is disclosed at least as the human readable data 108 on the substrate, and which, along with other optional data, is communicated to intended recipients by that computer.

Such functionally descriptive human and machine readable data would be adequate to enable the operation of the invention.

Other machine readable memory means 104 may optionally, or additionally, include an integrated circuit chip, optical bar codes, radio frequency tags, PCMCIA cards, and other memories which provide means to communicate with and control electronic devices as are well-known in the art. Additionally, other information may be appended to the message issued to the card maker or its agents through the functions of the machine readable data, such as the location and/or telephone number of the device reading the message card, identification of the card holder or card user, or other matters. The device reading and then transmitting the machine readable data on the Message Card could be an unmodified standard Point of Sale credit or debit reading device 402 forming part of a retail data system 408 or bank or debit card processing system 410, a calling card reader on a telephone 404, with a modem permitting communication via a Public Switched Telephone Network (PSTN) or other telecommunication system 412, or various other devices 406 that permit communication via machine readable means. It is not necessary that this system be limited to a closed system within an institution as the machine readable commands and data would suffice to direct the message and optional data to a computer operated by the card maker or its agents.

### Optional Additional Data

The other machine readable commands in the Message Card, or those transmitted by the central computer to the reader of machine readable data, may prompt the user of the Message Card to add to this message the auto repair shop's telephone by entering same on a key pad on the reading device after use of the Message Card, or be means for disclosure of the physical location of the data reading telecommunication device through caller ID or other such functions well known to those in the telecommunications industry. 110. Such data is not necessary for the disclosed data on the substrate to be received by intended recipients. Additional data, on whichever portion of the substrate and in human readable data, may also comprise an indication of the card holder's express consent for release of any rights to privacy of the data on the card, an alternative method of contact with the card holder or its insurer or agents, notification that the card is not a guarantee of payment for repair costs by any persons nor signifying execution of an insurance or other contract between the card holder and the card maker, or that no payments for repair of the vehicle will be made by mere use of the card as it is disclosed as not being a credit nor debit card. In such instances the card would not have upon it an expiration date for transmission of the machine readable data, nor an expression of any agreement between the card maker and card holder. Such human readable data may also comprise data disclosed in an additional optional data area 114. The Message Card would bear full disclosure, in human readable data, of all machine readable data 112. Denomination, or labeling, of such disclosure may be accomplished by an explanatory phrase as follows: “The following data constitutes all the data held by the magnetic stripe on this card.” Disclosure may also follow from the public display of the card, such as by suspending the card by a hole 102 in the substrate. Such information would clearly differentiate this card from standard credit or access cards. The card would not require a response but an embodiment may allow verification to the card holder or card user that the message was transmitted in total to a designated recipient via the PSTN or other means as is intended. An alternative embodiment may allow transmittal of information to the card holder or user on whether that policy number is valid, or to suggest the card holder and user contact parties other than the card makers, upon visual or other displays on the reading device. The human readable data may include international or common standards that are indicia of the mode of functions of the machine readable data, such as data element definitions and the format of data transmissions. The additional data may also include the identity of a natural person or legal entity other than the user, who is at least one intended recipient of the machine readable data to be transmitted.

### Method of Invention

This embodiment of the invention would also comprise a method or process through which the card maker would create or reconfigure software and a database within the central computer 414 regarding its customers or others 200, distribute Message Cards to a numerous card holders or users 202, by which the commands and data in the Message Card, or substrate, would be transmitted from the card holder or card user 204,206,208. The machine readable data on the message cards would be readable and transmitted by a variety of mechanical or electronic devices. Those devices may include unmodified point of sale devices 402 connected to retail data processing systems 408, by a number of devices connected to other telecommunication devices 404, 406, and by bank card and debit card reading devices and data systems 408, 410. The reading devices used may optionally verify the message was read accurately or offer an opportunity to add additional or optional information with the transmission of the message 210, and enable the process whereby that message and the other data would be sent via the retail data, bank card or other system to the central computer of the card maker or its agents 212. That message and data would reconfigure and convert the recipient central computer and/or database 414 to a device that would categorize the Message Card's data to fit within the card maker's parameters 214 in order to make the calculation or determine if the policy were in effect, store same data within the computer database 300, make the determination of which response is required by commands on the Message Card, and which card maker or agent thereof is to receive same message 302, issue same message and other data to the recipients 304, alter software and/or data in the central computer to record the message's time and content along with card holder data 306 and otherwise actuate a number of reconfigurations of software and data, such that the Message Card's data is combined with other data in the central computer before transmission to intended recipients.

However, the machine readable data on the substrate would be sufficient to trigger issuance of the disclosed message to the card makers, without addition of additional or optional, data.

The message issued to the appropriate recipients may include data such as the above information as well as contact information for the card holder or its agents to obtain further information to investigate the event, as the time and location the card was read and other such information as is within the memory of the database or is communicated to same. Such a process would result in receipt 308 of all basic information required for the card maker's adjusters or their agents to initiate an investigation to determine whether the executory contract that comprises the institution's relationship with the card holder has been triggered 310 by the message, and by any further information located by the adjuster. This method may alternatively issue prompts to request from the card holder or users the additional data as noted above, or may accommodate entry of same following directions in human readable text upon the substrate. The computer would reconfigure the programmed plan for distribution of data to various recipients as messages are received in a number of ways, perhaps on the basis of distributing messages from various card holders to specific recipients, or to choose new recipients once a predetermined number of messages are transmitted to a certain recipient within a certain period of time 306. Such computer programming would also record data on each message in a variety of applicable databases. The data issued to the appropriate recipients by the central computer 304 may, by reconfiguring the function of a visual display on a personal computer, or a personal digital assistant, a paging device, a telephone with an audible or digital communication, by fax of the data, printed or mailed via the United States Postal Service or other common carriers, and/or by reconfiguring functions of other selected methods, provide the appropriate data as intended. 416 The intended recipients of the message may all be persons other than the user of the message. Such a use of the Message Card would comprise a virtual call center such that no individual need collect further information nor respond at the time the Message Card's message is received, as is necessary in the work of ordinary call center personnel who receive personal auto accident information. The data would be sufficient such that an investigation to collect further information may begin at a later time.

Such use of a virtual call center in the preferred embodiment reflects an embodiment of the process and apparatus that discloses the theoretical and practical differences between devices comprising substrates with machine readable memories, and the Message Card. The Message Card functions to issue, via control of electronic or other machine readable data reading devices and computers and data display devices, messages or commands that are received by the card-making institution or its agents. With that information the institution or its agents are able to decide whether to issue benefits, or whether an executory contract is triggered. The decision on whether a contract's terms have been executed, the amount and timing of benefits or items or services purchased, and other decisions, are reached by the institution or its agents. That decision is not reached by the card holder or user.

### Functional Differences From Other Cards Bearing Data

There is no need to disguise or encrypt the message transmitted by the machine readable memory of the Message Card, so that the human readable data can fully disclose the machine readable data. Disguise or encryption on the ordinary credit card, access card or other devices comprising substrates with machine readable memories help identify the card holder as the unique individual who has the authority to execute a contract with the card maker. As mere use of the Message Card results in no execution of a contract between the card holder and the card maker, the disclosure of all data does not limit the function of the Message Card nor harm any card holder or card maker. Thus, not only may the machine readable data, in alphanumeric characters or ASCII or other means ordinarily known to those skilled in the art, be fully displayed in human readable data upon same substrate, but the Message Card may be pierced by an aperture and then suspended in full public view, perhaps from a vehicle mirror, in furtherance of the intended use of the functionally descriptive material. Even if no machinery is available to read the machine readable data, the full disclosure would permit reproduction of that transmission by use of a computer keyboard or telephone keypad to enter the disclosed data. Other elements of ordinary credit cards and access cards that are not necessary for the effective functioning of the Message Card are those which act as tokens to signify the card holder's identity or authority to use the card, such as the signature blank, the embossed name of an individual, or common holographic devices meant to prevent counterfeiting.

In ordinary credit and access cards, the card holder negotiates a contract of purchase or decides to enter a facility, and the card making institution only confirms that the contractual demands of the card holder will be met, e.g., that funds will be issued to fund the card holder's separate contract to make a purchase, or doors will open to allow access to a facility, once the intended use of the card confirms the present card holder's identification. The effective use of such cards requires that the response by the card maker be immediate, since undue failure to open a door or authorize release of funds for the separate contract of purchase would nullify the purpose and function of that card. A description of the need for an immediate release of funds, and a common institutional response to such need, can be found in the opinion in People v. Whight, 36 Cal. App. 4th 1143 (Cal. App. 3 Dist. 1995). In fact, it appears that point of sale systems and other means of transmitting machine readable data were devised to allow immediate verification of credit or authority to enter a facility on the part of the card holder. On many credit cards, express consent to the terms of the credit card agreement are signified by the card holder's signature upon, or use of, the credit card. Thus, the use of an ordinary credit card or access card involves execution of at least one or two contracts: The card holder's contract to purchase an item from a vendor and the card holder's contract with the card maker to fund same purchase; Or the decision to enter a facility and, upon proof of identity by use of the token or card, the card maker's execution of the contract to open the door due to the presence of an authorized person. The necessary element for ordinary credit cards or access cards to function is the identification of the card holder as the individual authorized to execute a contract with the card maker. There could not be full disclosure of machine readable data in human readable data, on such a card, as it would raise the threat of counterfeiting or identity theft. Within industry credit card standards, card security numbers are often encoded in machine readable data devised so that it cannot be understood or easily replicated by anyone other than the card maker.

### Functions of the Institutional Methods of the Invention

With the preferred embodiment of this invention, on the contrary, it is the institution, or the agents thereof, that makes the Message Card and receives the repetitively issued messages and, by institutional activities triggered by the use of functionally descriptive data on the Message Card, issues a decision on whether elements are present that would execute a preexisting contractual agreement with the card holder. The card holder does not decide to execute a contract nor make any decision other than to notify the maker of an event. This role allows a delay in the determination of whether the event resulted in an execution of the contract that may be triggered by the use of the Message Card. Thus, when use of the Message Card notifies an insurer of a personal auto accident, the institution or its agents may engage in a temporal delay to determine if the loss fits within elements necessary to execute the insurance contract. As the mere use of the Message Card does not obligate the card maker to acknowledge a contract has been executed with the card holder, the card need not signify on its face the card holder's agreement to any account agreements nor of other contracts with the card maker. In fact, an alternative embodiment of the Message Card expressly disclaims any warranty or guaranty that the mere possession or use of the card results in execution of contracts between the card holder and the card maker. An alternative embodiment may include a waiver of the card holder's rights to privacy as to information provided to the card maker or its agents, and signify absence of any contractual duty by the card maker or its agents to preserve the privacy of said information. By allowing notification of the card maker or its agents of an event, but without triggering execution of a contract by such use, the card holders and card makers have the option to exercise use of the Message Card in a flexible manner. Numerous individuals within one class, such as family members sharing use of an automobile, may be guided by, and utilize, the functionally descriptive material upon or within a single substrate. Those persons may use the Message Card effectively without having to be identified upon the substrate, nor by the card user, the card maker or its agents, as individuals authorized to be card holders.

### Functions Resulting From Full Disclosure

Effective use of a Message Card relies, in part, on an innovation which comprises the full disclosure, on the face of the message card, of the machine readable message. The expectations of a card holder of the functions of the Message Card, that immediate execution of a contract between the card holder and card maker will not occur merely upon issuance of data on the card, are such that allowing a third party to use the card will be of no danger to the card holder's assets nor obligate the card holder to unanticipated costs. On the contrary, ordinary access cards and credit cards and the processes by which they function are designed so that use by nonauthorized persons are voidable by the authorized card holder, or allow the authorized card holder to disavow such use, seek monetary damages or even criminal penalties against unauthorized users. Moreover, in the absence of a device to directly read the machine readable data, the full disclosure allows a person to use the keys of a telephone, or keyboard, to enter and transmit the identical message that is disclosed and that will then activate the functions of other devices, just as if a POS or other standard reader were utilized. Disclosure of international or common standards that are indicia of the mode of functions of the machine readable data would indicate the data elements definitions, the format of data transmission, and thus would indicate the method of use of the machine readable data if a device other than a standard reader of machine readable data were used.

### Machine Readable Data On A Single Substrate Suffices to Trigger Transmission of the Message

The Message Card also differs from customer loyalty cards, optical inventory systems and facility access cards in that the machine readable commands upon the Message Card suffice to communicate the message to a central computer and reconfigure the reader and the central computer and/or other devices, which central computer and other devices are not proprietary systems dedicated for use within one retail sales data system or security data system. The functions of access cards, customer loyalty cards or items such as bar coded labels on inventory control systems are limited to operation within a closed electronic system wherein they function if, and only if, information regarding the purpose for the human and machine readable data thereupon is added by the system upon use of the substrates. Therefore, a customer loyalty card from one card maker is generally inoperative when used in the retail information system of a competing card maker. A card granting access to one facility will not grant access to another card maker's facility. Not all machine readable product codes are universally in use among all retail or warehouse data systems, and not all barcoded information is disclosed in human readable digits or other characters. The undisclosed data such a system appends to data on customer loyalty cards and facility access cards is known only to certain authorized persons and not to all card holders or card users. Furthermore, any person would hesitate to use a customer loyalty card or facility access card on a card reader other than that authorized by the card maker, as without full disclosure of the machine readable message, the consequences of such use would possibly be adverse to the card holder's interests.

To the contrary, the Message Card would reconfigure the functions of data reading devices not dedicated to use within a single data system to allow communication with the card maker's central computer. The method of use of the embodiment may be through transmission of machine readable data through nonproprietary networks that are open and publicly-available transmission systems, as well as through a plurality of transmission systems that may include retail data processing systems 408 or bank card or debit card processing systems 410. That function is the one which is possible solely with full disclosure of data and the subsequent uses persons can make of the Message Card.

Many health insurance cards are in use to provide medical service providers with identification of a patient and a policy number and address to which to send treatment information in order to trigger benefits payable under the health insurance policy. Contrary to such cards, the Message Card does not merely convey human readable data such as a policy number and identification, but by use of the machine readable data reconfigures electronic readers to convey relevant information to a location distant from the card holder or card user. Particular information, such as that recorded by doctors or nurses, does not need to be sent with the electronically conveyed information in order to trigger an investigation, but allows investigation to begin with only the general information conveyed from the Message Card. Unlike other cards, no immediate reply regarding a contract with the card holder, such as treatment authorization, is required.

### Other Embodiments

### Replenishment of Inventory in Supply Chain

Another embodiment of the Message Card allows the apparatus to be a card 100 bearing human readable data signifying goods the card holder, XYZ Co., may purchase from an office supply company, in written or iconic or Braille form, among other means, comprising a message stating: “PLEASE SEND ONE UNIT OF THESE GOODS TO XYZ COMPANY” 108. The card may have an image of the goods or additionally have human readable data in multiple languages. Upon the placement of such substrate in a device 402,404,406 the machine readable message would be transmitted electronically or by other methods 412. At that time, the message would be transmitted 212, with additional, optional information such as the time of the entry on the device, the location of the device, and other information, to the computer of the card makers or their agents, or to a legal entity disclosed upon or within the substrate. Said computer would be reconfigured to accomplish appropriate transmittal of the data 302, for example to function differently in the event different goods were requested by various card holders. The card maker or agents receiving the message may then decide when or whether to supply such goods to the XYZ Co. 310 Such a decision may comprise elements such as whether the XYZ Co. had an executory contract with the card maker governing purchase of such goods, perhaps to purchase such goods only with a certain frequency, or to allow agents of the card holder's company, such as purchasing agents, to determine if the purchase would be appropriate. Those agents of the card holder may review messages from the numerous Message Cards upon data printouts or displays, the functions of which would be directed by the appropriate computer and database 308, based upon the frequency and types of supplies requested, determine its total needs and only later signify to the card maker or its agents that a contract to purchase some or all of the supplies requested may be executed 310.

### Communication to Family Members

Another embodiment is a card 100 with human readable and machine readable data signifying a message to be issued to other less formal institutions, such as families. A family member, perhaps a child while traveling, may have a card upon which the human readable message may be, “Upon use of this card the following message will be transmitted audibly through a telephone at number xyz and to email box xyz@xyz.com: I'VE RETURNED TO MY HOTEL FOR THE EVENING AND ALL IS WELL.” 106,108 Or, perhaps, the following, “Upon use of this card the following message will be transmitted audibly to telephone number xyz and to email box xyz@xyz.com: I'VE RETURNED TO MY HOTEL FOR THE EVENING AND WOULD LIKE YOU TO CALL ME WHEN CONVENIENT.” 106,108 That family member would be able to easily issue these short messages by use of a standard POS device or other device perhaps connected to a hotel room telephone, a cellphone, or to a personal digital assistant, among other devices that may comprise appropriate readers of machine readable data 402,404,406. Additionally, data may be appended to the message reaching the card makers or their agents within the family, such as the time or location of the transmission 210. The computer would be reconfigured to analyze and transmit this data 302,304. The institution, here comprising a parent obligated to care for the child, would decide upon an appropriate response 310. Instant messaging as generally used today, with cumbersome separate keying of messages, could thereby be much more convenient for sending repetitive messages.

Another embodiment would allow combination of the message card's key elements with those elements ordinarily found in standard credit cards, access cards and other such substrates. Upon ordinary use of those credit cards, and other such substrates, the invention would comprise a message that would be issued to a particular party or the to card maker or its agents. Such message would be disclosed upon the substrate that also functions as an ordinary credit card or access card. Such messages may comprise the following: “I'M AT THE TOLLBOOTH ON INTERSTATE 95 HEADED NORTH AND WILL BE HOME SHORTLY,” or, “I'VE ARRIVED AT WORK AND ENTERED THE BUILDING.” 308

### Assistance to the Disabled

An alternative embodiment of the Message Card may have the human readable data designed for those who are unable to manipulate ordinary electronic devices. Those persons, such as the blind, may have cards 100 wherein the human readable data is in Braille, as well as in visible text 106,108, so that the blind may easily issue messages to others by use of various data reading devices. An audible rendition of the message communicated for the intended recipient, including machine readable data 104 and additional data, would allow easy communication among blind persons.

### Other Alternative Embodiments

An alternative embodiment may include numerous machine readable memories upon a single card, so that multiple discrete messages in machine readable data may be issued by the Message Card.

An alternative embodiment may comprise Message Cards issued by an individual not a member of an institution, and issued to a card holder who is also an individual. The same individual issuing a Message Card could be a recipient of messages from use of the card. Personal greetings or petitions may thus be repetitively exchanged.

An alternative embodiment may comprise Message Cards issued by card makers as a part of a game or other entertainments. A game move can be represented upon one card. Thus, entering a card disclosing the label “This card is XYZ” would enter upon an electronic game system the move denominated “XYZ” on behalf of the player entering that card onto a device reading the machine readable data.

While the foregoing descriptions contain many specificities, they should not be construed as limitations on the scope of the invention, but rather as exemplifications of a variety of embodiments. Accordingly, the scope of the invention should be determined not by the embodiments illustrated, but by the claims that are appended and their legal equivalents.

What is claimed is:

1) A communication apparatus for transmission of a message, disposed therein or thereupon, to recipients other than the user, comprising:
a) a substrate;
b) machine readable data disposed upon or within said substrate comprising commands directing a communication device to transmit said message, and additional machine readable commands and additional data disposed upon said substrate, to said recipients; and
c) human readable data disposed upon or within said substrate, fully disclosing at least said message in a form readily interpretable and reproducible by the unaided human.

2) The communication apparatus of claim 1 wherein or whereupon is situated additional human readable data that comprises directions for use of said communication apparatus.

3) The communication apparatus of claim 2 wherein or whereupon is situated additional human readable data that comprises full disclosure of all said machine readable data upon or within said substrate.

4) The communication apparatus of claim 3 wherein or whereupon is situated additional human readable data comprising disclosure of international or common standards that are indicia of the mode of the functions of said machine readable data.

5) The communication apparatus of claim 4 wherein said human readable data is denominated, by additional human readable data, as comprising full disclosure of all said machine readable data upon or within said substrate.

6) The communication apparatus of claim 1 wherein said machine readable data comprises means for reconfiguring standard point of sale credit or debit reading devices, upon input of said machine readable data, such that said devices transmit at least a portion of said machine readable data to a plurality of cardmakers, their agents or other intended recipients, all of which said recipients are persons other than the user of said communication apparatus.

7) A communication apparatus comprising:
a) a card-like substrate;
b) machine readable data disposed upon or within said substrate;
c) human readable data, disposed upon or within said substrate, and fully disclosing at least said machine readable data;
d) software and command data means for directing electronic and mechanical devices to transmit at least a portion of said machine readable data;
e) additional human readable data disposed upon or within said substrate and comprising directions for use of said communication apparatus; and
f) additional human readable data disposed upon said substrate and denominating other human readable data on said substrate as a full disclosure of said machine readable data.

8) The communication apparatus of claim 7 wherein entry of said machine readable data into a plurality of devices transmits at least a portion of said machine readable data to intended recipients other than the user of said communication apparatus.

9) The communication apparatus of claim 8 wherein said substrate is card-shaped and wallet sized.

10) The communication apparatus of claim 9 wherein said machine readable data comprises means for reconfiguring electronic and mechanical devices to transmit data revealing the location of said telecommunication device to said recipients .

11) The communication apparatus of claim 10 wherein is disposed in additional human readable data the identity of a person other than the user, who is at least one intended recipient of said machine readable data to be transmitted upon use of said communication apparatus.

12) The communication apparatus of claim 11 wherein is not disposed an expiration date for transmission of said machine readable data nor an expression of any agreement between the card maker and the card holder.

13) The communication apparatus of claim 10 wherein or whereupon is located a plurality of items bearing machine readable data.

14) The communication apparatus of claim 13 wherein said communication apparatus is pierced by at least one aperture whereby said apparatus may be suspended from another object.

15) A method of providing a communication service for machine readable data on or in substrates, comprising the steps of:
a) creating or reconfiguring software and a database of a central computer containing data regarding individuals, institutions or legal entities;
b) distributing said substrates to a plurality of holders or users;
c) reading of at least a portion of said machine readable data by a variety of electronic or mechanical devices;
d) indicating to users of said devices that said machine readable data was accurately read by said devices;
e) directing transmission of said machine readable data and other additional data input to said central computer by a plurality of data transmission systems;
f) reconfiguring said database, upon receipt at said central computer of said machine readable data and said additional data such that said data is combined and stored, and intended recipients, including legal entities, cardmakers or their agents, are identified;
g) transmitting a plurality of data or software from said central computer to at least one of said intended recipients, legal entities, cardmakers or their agents;
h) recording information comprising data or software transmitted from said central computer to said intended recipients or others, and reconfiguring said database and programming;
i) displaying said plurality of data or software on a variety of electronic or mechanical devices in possession of said intended recipients, legal entities, cardmakers or their agents; and
j) determing the appropriate response, if any, by said intended recipients, legal entities, cardmakers or their agents.

16) The method of claim 15 wherein said machine readable data includes sufficient software commands and data to actuate at least one of a plurality of reconfigurations of software and data of said central computer, such that at least a portion of said machine readable data upon or within said substrate is transmitted to entities other than the user of said substrate, said entities comprising said intended recipients, cardmakers, their agents, individuals or other legal entities.

17) The method of claim 16 wherein said substrates display said machine readable data in human readable data.

18) The method of claim 17 wherein said machine readable data is read and transmitted by unmodified point of sale devices connected to retail data processing systems.

19) The method of claim 18 wherein said machine readable data is read and transmitted by a plurality of devices connected to telecommunication devices.

20) The method of claim 19 wherein said machine readable data is read and transmitted by bank card or debit card reading devices and data systems.
